(19) United States
(12) Patent Application Publication
(10) Pub. No.: US 2019/0222054 A1
(43) Pub. Date: Jul. 18, 2019

(54) ENERGY SUPPLY ARRANGEMENT

(71) Applicant: RailCare AG, Härkingen (CH)

(72) Inventors: Josef ZETTEL, Hohenrain (CH); Philipp WEGMÜLLER, Kilwangen (CH); Beat WEGMÜLLER, 4950 (CH)

(73) Assignee: RailCare AG, Härkingen (CH)

(21) Appl. No.: 16/303,062

(22) PCT Filed: May 18, 2017
(86) PCT No.: PCT/EP2017/061975

§ 371 Date: Nov. 19, 2018

(30) Foreign Application Priority Data
May 20, 2016 (EP) 16170655.1

(51) Int. Cl. H02J 7/32; H01M 2/10; H01M 10/46; H02J 7/02; B60R 16/02

(52) U.S. Cl. CPC H02J 7/32; H01M 2/1083; B63B 25/004; H02J 7/02; B60R 16/02; H01M 10/46

(57) ABSTRACT

The invention relates to an energy supply (11) for supplying an energy consumer with electrical energy. The energy supply (11) comprises a mounting device (20) as well as a battery (29), a charger device (30) and a load connection (33). The energy supply (11) also comprises an energy connection for connecting an energy source, and an energy converter (31) for converting the energy received at the energy connection into a form of electrical energy which is suitable for charging the battery (29). The energy which is stored in the battery (29) can then be made available at the load connection (33) for supplying one or more energy consumers which are connected thereto. The mounting device (20) is provided here with connecting devices (23, 24) which are compatible with those attachment devices with which corresponding transportation containers can usually be connected to a transportation vehicle. It is therefore possible to arrange such an energy supply (11) for transporting a transportation container between the latter and the appropriate transportation vehicle, wherein for example the kinetic energy of the moved transportation vehicle can be utilised for the charging of the battery (29) in that e.g. the rotation of the wheel axle of the vehicle is converted into electrical energy with a hydraulic generator.

### TECHNICAL FIELD

The invention relates to an energy supply arrangement for supplying an energy consumer with electrical energy, having a mounting device, on which are arranged an energy connection for receiving energy, an energy storage device for storing electrical energy, a charging device for storing energy, received at the energy connection, in the energy storage device, and a load connection for connecting the energy consumer for the purpose of supplying the energy consumer with the electrical energy stored in the energy storage device. The invention further relates to a transport container connected to such an energy supply arrangement, and to a vehicle connected to such an energy supply arrangement, and to a method for supplying an energy consumer with electrical energy by means of such an energy supply arrangement.

### PRIOR ART

Worldwide, there is a progressive increase, not only the mobility of people, but also in the transport of goods. Such goods in this case may include all goods whose place of production or manufacture is not the same as the place of use, or consumption. The range of such goods or commodities, hereinafter also referred to in general as freight, extends, for example, from simple ballpoint pens, to electronic devices, to installations or structural elements for power plants. And it extends, for example, from raw materials—for instance for the chemical, pharmaceutical or foodstuffs technologies—to corresponding intermediate products, to long-storage or highly perishable foodstuffs.

For transport over greater or lesser distances—depending on the application, this may be a few kilometers up to some multiple thousands of kilometers—many of these goods are stored in transport containers, which typically are more easily transported than the goods in their original packaging or any other containers in which such goods are normally stored. Usually, standardized containers such as, for instance, containers according to the ISO Standard 668, are used for the mass transport of freight. Such standardized or otherwise uniform containers have the advantage that, on the one hand, they are easily stacked, and on the other hand they can be transported by any vehicle designed for transporting such standardized containers.

Frequently, the transporting of such transport containers from the start location to the destination is effected by use of different vehicles such as, for instance, ships, trains or lorries.

Frequently, also, in the transporting of goods, certain conditions must be observed so that the goods themselves are not destroyed, or so that their quality is not adversely affected by the transport. For longer transport, certain foodstuffs have to be kept under sometimes even changing environmental conditions. Bananas, for example, are transported over long distances in a hibernation atmosphere, in order to prevent early ripening. In the case of other goods, again, their temperature is very important. Many foodstuffs such as, for instance, milk products or frozen products, must be transported, for example, in a chilled or even frozen state, so that they do not spoil during transport. Other products such as, for instance, gases or liquids, frequently must likewise be temperature controlled, with transport in some cases also having to be effected under prescribed pressure conditions. To transport bitumen, for example, it must be heated, so that it does not harden.

Heating systems, refrigeration systems or other devices for setting and regulating particular transport conditions generally require energy or other operating substances such as, for example, fuels or coolants, or also electrical energy, for their operation.

Known from DE 1 940 999, for example, is a refrigerated wagon, which has two air-conditioning groups, which are fastened to the outside of the wagon body, and which are operated either with electrical energy or with liquid nitrogen, the nitrogen being carried along and the electrical energy being generated by generators that are driven by the wheels of the vehicle. Additionally provided are plug-in connectors, via which the air-conditioning units can be supplied with energy from the outside. On the one hand, in this case there arises the problem that, when the refrigerated wagon is at a standstill and when there is no external electricity source available, refrigeration of the refrigerated wagon cannot be ensured. Also, the quantity of hydrogen carried along will also be used up eventually. This means that, either the refrigerated wagon must be moved regularly, or nitrogen must be replenished, or the refrigerated wagon must be supplied with electricity in some other way. All this means a large logistical resource requirement.

Known from the German utility model G 93 03 046 U1, for example, is an articulated carrier wagon for transporting refrigerated containers and/or refrigerated swap bodies, which has a diesel-generator unit, which serves to supply electrical energy to refrigerated containers or refrigerated swap bodies that do not have their own energy supply for their refrigeration and/or heating systems. The necessary fuel for the diesel generator must likewise be carried along during transport, the quantity of fuel being limited in this case also, and consequently being sufficient for a limited time only. For longer transports in this case there is also a greater logistical resource requirement.

Known from EP 2 647 540 A1 is another energy supply for refrigerated containers transported by rail, in which the container carrier wagon carrying the refrigerated container comprises a transformer, in order to convert the electrical energy, delivered from the electric locomotive via heating cables, into a form of electrical energy suitable for operating the refrigerated container. The greatest problem with this solution arises in international transport, because the railway infrastructures in some cases are based on differently designed mains energy supply systems that are not mutually compatible. This means that the transformer would either have to be designed for different input voltages, or a plurality of transformers would have to be provided—one for each possible mains energy supply system. Both of these are resource-intensive and expensive.

It is also known, from DE 41 15 964, to use solar energy for operating mobile refrigerating equipment with a cold-vapor refrigerating machine. In this case, the refrigerated vehicle is equipped with solar cells, a solar generator charging an energy storage device, the charge of which is ultimately used to operate the refrigerating machine. As is known, solar systems only deliver sufficient electricity when there us sufficient solar radiation. In countries with little solar radiation, or if the solar radiation is reduced for other reasons, for example because of bad weather lasting for days, this system does not deliver sufficient energy to maintain the required transport conditions for a sufficiently long period.

Moreover, the aforementioned known solutions all have the problem that their use requires the specific equipping of respective transport containers and/or the corresponding transport vehicles. These solutions are therefore expensive, and furthermore cannot be used in a flexible manner, i.e. with different transport containers and/or different transport vehicles.

Presentation of the Invention

The object of the invention is to create an energy supply arrangement, belonging to the technical field mentioned at the outset, which avoids the disadvantages of the aforementioned prior art and, in particular, makes it possible to provide a favorable and flexible solution for supplying energy to energy consumers in connection with the transport of goods. Further objects of the invention are to create a corresponding transport container, a corresponding vehicle and a corresponding method for supplying an energy consumer with electrical energy.

The achievement of the object is defined by the features of claim 1. According to the invention, the mounting device comprises a first connection device, for separable connection to a fastening device of a transport container for connecting the transport container to a transport container of the same type or to a vehicle. The vehicle in this case is either a rail vehicle, a motor vehicle such as, for example, a lorry, or a water vehicle such as, for example, a ship.

Such a transport container may be a closed container, as well as an at partly open container, for example a container having a base and ends, but without a top and side walls. Preferably, however, the transport container is a standardized container for goods transport, as mentioned above. The term container is also understood to mean other containers such as, for example, swap bodies or swap trailers. This enables the invention to be used with a multiplicity of transport containers used in goods transport.

In this way, the mounting device, and therefore clearly also the energy supply arrangement that comprises such a mounting device, can easily be fastened to such a transport container, or connected to such a transport container. For the purpose of supplying energy to the energy consumer, the latter only has to be connected to the load connection, and the energy consumer can be operated with the energy stored in the energy storage device—without dependence on energy sources that would have to be carried along on or in the transport container. Since that fastening device of the transport container by which the transport container is otherwise connected to a vehicle or to a transport container of the same type is used to connect the energy supply arrangement to the transport container, the transport container does not have to be worked, supplemented or modified in any way for the purpose of using the invention. Accordingly, the invention can be used with any transport container that has a corresponding fastening device. The specific nature of the latter depends, in turn, on the type of transport container with which the invention is to be used.

A further advantage of the invention is that, owing to this design of the energy supply arrangement with a mounting device and components fastened thereto, the energy supply arrangement, after having been connected to a corresponding vehicle, for example a container carrier wagon, is considered as load, and not as part of the carrier wagon, at least in certain countries. As a result, less stringent regulations apply to the specific design of the energy supply arrangement. Moreover, the energy supply arrangement can be removed again from a vehicle at any time and without permanent changes to the latter.

The energy storage device preferably comprises a battery, in which the supplied electrical energy is stored in the form of chemical energy. In principle, however, the energy storage device may also comprise other storage variants for storing electrical energy, such as, for instance, capacitors or flywheels, but the capacity of these storage devices is still too small to enable them to be used commercially.

The energy consumer is, for example, a refrigeration unit for refrigerating the freight to be transported in a transport container. It may also be a heating device, by which the freight can be heated. A system for applying gas to the freight may also be such an energy consumer. Clearly, however, it is also possible to operate any energy consumer, not necessarily directly associated with the freight, by means of the energy from the energy storage device. The energy consumer could thus also be a lighting system for the transport container, an automatic feeding system for feeding animals conveyed in the transport container, or also electronic devices such as, for example, a music system or even a multimedia system.

To enable the energy supply arrangement to be fastened, not only to a matching transport container, but also to, in or on a vehicle for transporting such a transport container, i.e. to be connected to such a vehicle, in a preferred embodiment of the invention the mounting device comprises a second connection device, for separably connecting the mounting device to a fastening device of the vehicle for connecting the vehicle to the transport container.

In this way, the mounting device, and therefore clearly also the energy supply arrangement, can easily be connected to such a vehicle, for example fastened on the vehicle. Since that fastening device of the vehicle by which a transport container is otherwise connected to a vehicle is used to connect the energy supply arrangement to the vehicle, the vehicle itself does not have to be worked, supplemented or modified in any way for the purpose of using the invention.

Accordingly, the invention can be used with any transport container that has a corresponding fastening device. The specific nature of the latter depends, in turn, on the type of transport container with which the invention is to be used.

As already mentioned, such transport containers, for example containers according to the aforementioned ISO standard, for goods transport are usually transported by means of one or more vehicles. A container, with the goods to be transported, is collected, for example, at the start location by a lorry, brought by the lorry to the next loading station, for loading such containers onto the rails, there pushed onto a rail vehicle, for example a container wagon, transported by rail to a loading station close to the destination, where the container is again reloaded onto a lorry and finally brought by the latter to the destination (combined transport).

Such ISO containers are used, in particular, because they are typically designed in such a manner that their load volume can be utilized optimally with smaller transport containers such as, for instance, Euro pallets.

As a rail vehicle for transporting such containers, it is possible to use all rail wagons that have the corresponding fastening devices, or to which such fastening devices can be attached, and with which there is sufficient remaining height space for such a container. Typically, various types of flat wagon are used for container transport.

The fastening device of the vehicle for connecting the vehicle to a transport container typically comprises a plurality of studs, which have particular dimensions, such as height and diameter, or height, length and width, and which are arranged in a rectangle that has a defined width and a defined length. The studs are arranged, for example, with a lateral spacing of 2260 millimeters and a longitudinal spacing of 5853 millimeters and, depending on the length of the vehicle, a plurality of such sets of four studs may also be arranged in succession on the vehicle. The ISO container mentioned at the outset is available, for example, with a width of 8 foot and in different, defined lengths of, for example, 20 or 40 foot. The term foot in this case refers to the English linear measure ft, in which one foot measures 30.48 cm. A 20-foot container will then use, for example, one such set of four studs, a 40-foot container accordingly uses two sets of four studs arranged in succession, etc. It is to be noted that not every container position of a vehicle necessarily has to be equipped with corresponding studs, since the studs may also be realized such that they can be easily removed and re-attached.

In such a case, the fastening device of the transport container for connecting the transport container to a transport container of the same type, or to a vehicle, then comprises a plurality of openings that are correspondingly arranged in a rectangle, and that serve to receive the studs. For this purpose, the studs normally have an external conical shape, and the openings have a matching internal cone. There are systems in this case in which such a transport container is merely placed with its openings onto the studs. Further, there are systems in which a transport container placed with its openings onto the studs of a vehicle can additionally be secured, so that it does not become detached during transport. Such a connection device may also be used to connect one transport container to another structurally identical transport container, for example to stack them. Structurally identical in this case is to be understood to refer to the connection device, since the transport containers may be quite different in their specific design.

Obviously, the studs and openings may also be transposed, i.e. the studs may also be provided on the transport container, and the openings on the vehicle. It is clearly also possible for a transport container and a vehicle to be separably connected to each other by another type of connection or fastening device, for example other non-positive and or positive connections for transporting the container with the vehicle, the connections being able to be both secured and unsecured. This also applies to connection devices for connecting two transport containers.

The energy received at the energy connection may have quite different forms. It may be, for example, thermal, chemical, potential, kinetic, or any other conceivable form of energy. It may also be electrical energy produced, for example, by means of photovoltaics or wind power, from or on the vehicle itself. In most cases, therefore, the received form of energy is not suitable for direct storage in the energy storage device. In an advantageous exemplary embodiment of the invention, the energy supply arrangement therefore comprises an energy converter for converting the energy received at the energy connection into electrical energy that can be stored in the energy storage device by the charging device. The energy converter necessarily differs in design according to the type of energy source. For instance, if energy delivered at the energy connection is in chemical form, for example in the form of fuel such as natural gas, diesel or petrol, etc., the energy converter may comprise, for example, an electric generator that can be operated with the fuel and that converts the chemical energy, stored in the fuel, into electrical energy for storage in the energy storage device.

If, on the other hand, energy is delivered at the energy connection in thermal form, for example in the form of water vapor, the energy converter advantageously comprises a turbine that can be operated with the water vapor and that thereby produces electrical energy.

Clearly, the energy received at the energy connection may also be electrical energy, which can be stored directly in the energy storage device. In another example, however, electrical energy is delivered to the energy connection in the form of an a.c. voltage. If the energy storage device in this case is a battery, the received electrical energy, before being stored, would still have to be converted into a d.c. voltage.

In a preferred exemplary embodiment of the invention, however, the energy is delivered in the form of kinetic energy. This kinetic energy originates, for example, from a vehicle by which the transport container is transported, and to which transport container the energy storage device is connected. For example, the energy of motion of the vehicle, i.e. the speed difference between the vehicle and the ambient air, could be utilized by means of wind wheels or similar elements. However, the quantity of energy that can be produced in this case is highly dependent on the environmental conditions, specifically the wind conditions, and is therefore difficult to calculate. Preferably, therefore, the rotational energy of a rotating element of the vehicle such as, for instance, the rotational energy of an axle or a wheel of the vehicle, is used. Although this energy source is only available when the vehicle is moving, it is non-dependent on other conditions, such as the weather, that normally cannot be influenced. Accordingly, the energy converter advantageously comprises a generator for converting a rotational energy of a rotating element of the vehicle into electrical energy.

For this purpose the energy converter may comprise, for example, an arrangement of shafts, couplings and gear sets, by which the rotational energy can be mechanically transmitted to the energy connection. The energy converter then further comprises a generator, by which this rotational energy can be converted into electrical energy. However, realization of such a mechanical transmission is complex, and therefore expensive. It also comprises a multiplicity of moving parts, such that there is also an increased risk of injury to persons or damage to objects that come into proximity of the vehicle. Another possibility consists in attaching the generator to the vehicle, to a wheel axle or to a wheel, or in proximity thereof, in such a manner that the generator can directly utilize the rotation of the axle or of the wheel to generate electrical energy, which can then be transmitted to the energy connection by means of electric power cables, or which can also be used directly, to charge the energy storage device. Depending on the length and arrangement of these electric power cables, however, there is the risk that other electrical or electronic devices or components may undergo interference or be affected by the fields generated by the currents flowing in the cables. This is normally undesirable. In particular, if such electric power cables are mounted on the axle of a container wagon, this could result in unwanted interference to the railway technology on the container wagon, or also along the tracks.

In the case of a preferred exemplary embodiment of the invention, the energy converter therefore comprises a hydraulic generator for converting the rotational energy of a wheel axle of a vehicle into electrical energy. The hydraulic generator, in turn, comprises a hydraulic pump and an electric generator. Whereas the electric generator is fastened to the mounting device, the hydraulic pump can be fastened to the wheel axle and can be connected, via hydraulic hoses, to the electric generator. The hydraulic pump, using the rotation of the wheel axle, pumps a hydraulic fluid through a hose to the generator, and through another hose back again to the hydraulic pump, where the circuit of the hydraulic fluid closes again. The fluid flow of the hydraulic fluid in the generator puts, for example, the rotor of the electric generator into rotation, such that, by combined action with the stator of the electric generator, electric current is produced. This may be an alternating current, or also a direct current, which can then be stored in the energy storage device.

By means of such an energy converter, the rotational energy of a wheel axle can be converted, in a simple and efficient manner, into electrical energy for storage in the energy storage device.

As already mentioned further above, electrical energy may also be available in many form types. This means that it may be available as alternating current having differing amplitudes and frequencies, but it may also be available as direct current of differing voltage. For the purpose of storage in a particular energy storage device, i.e. for example in a particular type of battery, the electrical energy must typically be available in a particular form. In the case of batteries this is normally a direct current, with which the battery can be charged more rapidly or more slowly, depending on the current intensity.

Usually, the form of the electrical energy delivered at the energy connection or generated by the energy converter does not match the form of electrical energy needed to charge the energy storage device. The energy supply arrangement therefore advantageously comprises a current converter for converting the electrical energy delivered at the energy connection or generated by the energy converter into a form of electrical energy suitable for charging the energy storage device.

The current converter is designed in such a manner that it serves, as a d.c. voltage converter, to convert a direct current that is unsuitable for charging a battery into another direct current that is suitable for charging the battery. However, since electrical energy is frequently generated in the form of an alternating current, in particular if it is generated by a rotary motion, or rotation, the current converter is advantageously realized as a rectifier, for converting an alternating current into a direct current suitable for charging the battery.

The current converter not only serves to convert the energy, provided by the energy converter, for storage in the energy storage device, but is preferably also designed to convert the electrical energy provided by the energy converter into a form of electrical energy that can be used for operating the energy consumer and that can be output at the load connection. Since most energy consumers require current in the form of an alternating current, the current converter is preferably realized in such a manner that it converts an alternating current, delivered by the energy converter, into an alternating current that can be used for operating the energy consumer. Depending on the type of the electrical energy supplied by the energy converter, or on the form of electrical energy required for operating the energy consumer, the current converter may clearly also be designed for converting direct current into direct current, direct current into alternating current, or alternating current into direct current. The current converter in this case may be realized as a unit that can perform all of the required conversions, this being able to be effected by a single multifunctional circuit or by a plurality of individual, specifically designed circuits that are accommodated in a common device unit. However, the current converter may also comprise a plurality of units, each of which performs one or more of the required conversions, and which are controlled in an appropriate manner. It is clearly also possible to provide a current conversion in the energy converter, whether this be an AC/DC, AC/AC, DC/DC or also DC/AC conversion.

In a preferred embodiment of the invention, the energy supply arrangement comprises a mains power supply connection, for connecting an external electrical energy source. Such an external electrical energy source is, for example, a mains electricity supply system, such as that which is frequently available at locations where transport vehicle, or transport containers, are parked, for example for a short period or over several hours, or also over days or even longer periods of time. Such external mains electricity systems are frequently available in such container or lorry terminals, as well as in railway stations or goods railway stations, where such transport rail wagons are frequently parked for short or longer periods.

Such mains electricity systems normally supply a locally customary form of alternating current which, for example in Switzerland and in some other parts of Europe, is a three-phase alternating-current mains system having three phase conductors, one neutral conductor and usually one ground conductor. If three-phase current is not required, only a one-phase alternating-current mains system is also sufficient. In the above-mentioned regions, the voltage of a phase with respect to the neutral conductor is typically 240 volts a.c. voltage, and the voltage between two phase conductors is typically 400 volts a.c. voltage. This at a mains system frequency of, for example, 50 or 60 hertz.

The energy supply arrangement, or its charging device, in this case is designed, in particular, to store electrical energy, received at the mains power supply connection, in the energy storage device. The energy supply arrangement is also advantageously designed to directly supply an energy consumer, connected to the load connection, with electrical energy received at the mains power supply connection.

If such a mains system connection is present, upon each shorter or also longer transport interruption the energy supply arrangement, or the transport container to which it is connected, can be connected to such an external mains electricity supply system, and can use the energy of the latter not only to replenish the energy storage device, but also to supply the energy consumer with the required energy from the mains electricity supply during this period.

It is clearly also possible to use the energy supply arrangement in a stationary manner, for example at a location where such transport containers are stored, whether empty or loaded. For this purpose, the energy supply arrangement may be solidly mounted on the floor, in a separable or also fixed manner, or on corresponding frames for receiving suitable transport containers.

Clearly, not only it is possible for energy to be received via the mains system, it is also possible for the energy received at the energy connection or the energy stored in the energy storage device to be fed into the connected mains system via the mains system connection.

As already mentioned, the energy consumer may be any item of equipment, an apparatus, a lighting system or other device that can be operated with electric power. The energy consumer also need not necessarily be part of the transport container or be arranged at, in or on the transport container. It may also be, for example, an item of equipment or other device that is, for instance, part of the vehicle or arranged on the vehicle. However, the energy consumer may also be, for example, an energy consumer such as, for example, a lighting system of a terminal for the intermediate storage of transport containers or the corresponding transport vehicles.

In the case of a preferred embodiment of the invention, however, the energy consumer is arranged on or in the transport container and comprises, in particular, a temperature adjustment device, by which the load volume of the transport container can be brought to a particular temperature. Frequently, this is a refrigeration device, a heating device, or a combined refrigeration and heating device such as, for example, an air-conditioning system.

Such a temperature adjustment device normally comprises a refrigeration and/or heating unit that can be operated electrically, and that can then be operated with the energy provided by the energy supply arrangement.

As already mentioned, there are any number of types and models of transport containers that can be equipped with an energy supply arrangement according to the invention. For this, it is merely necessary for the connection device of the mounting device to be matched to the fastening or connection device of the transport container, so that it is compatible with the latter. In the case of transport container types that are used frequently, it is worthwhile to produce corresponding mounting devices. In the case of transport container types that are not used frequently, it may be the case that it is scarcely worthwhile to provide corresponding mounting devices.

The containers mentioned at the outset, in particular those according to the ISO Standard 668, are amongst the most frequently used transport containers for the transport of freight, in both national and international transport, and in particular in multimodal transport, i.e. in the transport of such containers by means of at least two different transport vehicles. The invention can be used particularly effectively especially in intermodal transport, in which goods are transported in one and the same load unit by means of at least two modes of transport. However, this also applies particularly in combined transport, in which as great a proportion of the transport distance as possible is completed by rail or by ship, and the initial and final parts by road are kept as short as possible.

In the case of a preferred embodiment of the invention, the transport container is consequently such a container, and accordingly the first connection device, for separably connecting the mounting device to such a container, is matched to the fastening or connection devices of such containers for connection to a suitable vehicle or a structurally identical container. This enables the invention to be used flexibly with a multiplicity of different such containers, in particular such containers according to the aforementioned ISO standard. Such containers can be transported by means of a great variety of vehicles, which are also equipped accordingly for this purpose, i.e. have the corresponding connection devices.

As already mentioned, the energy storage device is preferably a battery. This may be a battery that has a particular, predefined capacity, and that is integrated in the energy supply arrangement. If, in such a case, there is a change in the requirements relating to the energy supply arrangement, for example that another energy consumer, having a greater energy consumption, is to be supplied, the battery can be replaced by a battery of greater capacity.

It is simpler, however, and therefore also preferred, that the energy storage device is of a modular design and accordingly has a plurality of accumulator cells, such that the number of individual cells, and therefore the capacity of the energy storage device, can in each case be flexibly adapted to the electric power required at a particular time. Typically in this case, however, individual accumulator cells are not added or removed, but a particular number of accumulator cells is preferably interconnected to form groups, each group of cells forming a block, and these blocks being able to be added or removed in a modular manner. Or these blocks are combined to form yet larger groups, units referred to hereinafter as accumulator modules that, for their part, can be added or removed in a modular manner. In this way, the capacity of the battery can be adapted in a simple and flexible manner to the electrical energy required for the transport of particular goods.

As already mentioned, the mounting device comprises a first connection device, for separably connecting the mounting device to a fastening device of a transport container for connecting the transport container to a transport container of the same type, or to a vehicle. In addition, the mounting device may also comprise a second connection device, for separably connecting the mounting device to a fastening device of a vehicle for connecting the vehicle to the transport container.

In order that, in the transport of transport containers that are to be supplied with energy, the energy supply arrangement according to the invention can be used as easily and as flexibly as possible, the mounting device is advantageously realized as a frame, hereinafter referred to as an adapter frame. This adapter frame can be installed between a vehicle and a transport container to be transported for transport by the vehicle, the respective fastening or connection devices being used. The adapter frame preferably has a basic rectangular shape, having a length and a width that correspond substantially to a length and a width of the transport container, or that is matched to the fastening or connection devices present. The adapter frame is also of low height in comparison with the length and width. This height in this case is preferably selected such that the total height of the adapter frame and transport container does not exceed the permitted total height of the load of the corresponding transport vehicle. For example, many of the above-mentioned 20-foot or 40-foot long ISO containers have a height of 8.6 foot, which corresponds to a height of nearly 2.60 meters. In order not to exceed the permitted total height with such containers, for example in the case of transport by rail by means of container wagons, the height of the adapter frame is, in particular, not more than 25 cm, and preferably not more than 11 cm.

The energy supply arrangement may be designed for autonomous operation. It may be designed, for example, in such a manner that it does not require a closed-loop or open-loop control of a refrigeration device that is present, and supplies the latter with a particular quantity of electric power for as long as this is available. In this case, however, it may happen that the freight undergoes excessive or inadequate refrigeration, depending on the environmental conditions. The energy supply arrangement therefore preferably comprises a control device for controlling an energy flow between a mains system connection, energy converter, energy storage device and an energy consumer connected to the load connection. In this way, the energy consumer can be supplied with a greater or lesser amount of energy in each case, depending on its energy requirement.

In this context, it should be mentioned that the load connection is designed, in particular, for connecting a plurality of energy consumers, and the control device is accordingly also designed to control an energy flow between mains connection, energy converter, energy storage device and a plurality of, or all, energy consumers connected to the load connection. It is to be noted that the design of the load connection may also be non-dependent on the presence of a control device for connecting a plurality of energy consumers.

Since it may happen that no more energy is being stored in the energy storage device, the energy supply arrangement preferably comprises an auxiliary energy source, for example an auxiliary battery provided in addition to the energy storage device. This auxiliary battery in this case serves to maintain the system of the energy supply arrangement, if the energy storage device is empty, or also for other reasons. It also serves, for example, to start up the energy supply arrangement from a sleep mode, which may be provided if the energy supply arrangement is not used over a particular period of time, or which may also be initiated manually if the energy supply arrangement is not required.

In the transport of goods in which particular transport conditions must be observed, it is normally important to ensure that these transport conditions are also actually observed during the entirety of the transport. This, for example, to prevent foodstuffs from spoiling or, as mentioned above, from ripening too early.

The energy supply arrangement therefore advantageously comprises a monitoring device for monitoring a transport container connected to the energy supply arrangement. This monitoring relates, in particular, to the temperature at one or more locations within the transport container or to the maintenance of a particular gas atmosphere in the transport container. However, it may also be used, for example, to monitor the position of the transport container, to enable it to be located if required. This is not only helpful if the progress of the transport is to be monitored, but also if, for whatever reasons, the transport container is not where it should be, whether as a result of having been lost or also as a result of theft. The monitoring device in this case is preferably designed to receive and process signals originating from sensors, arranged on or in the transport container, that serve to monitor freight transported by means of the transport container.

Obviously, the monitoring device can also perform further functions such as, for instance, monitoring of the container or also of the energy supply arrangement itself.

To enable the energy supply arrangement to communicate also with other units, for example other energy supply arrangements or a central office, i.e. to send and/or receive signals such as, for example, control or monitoring signals, in the case of a preferred exemplary embodiment of the invention it comprises a communication device for sending and/receiving such signals. Possible for this, in principle, is any communication device that is suitable for the exchange of such signals, including also wired communication devices that are connected, for example by cable, to a corresponding station at a terminal, etc., and that can then exchange data via this cable. An example of this would be, for instance, a LAN, to which the communication device can be connected. However, precisely because a transport container is often not stationary, but in motion, the communication device is preferably designed for wireless, and in particular bidirectional, communication. For this purpose it has, for example, a mobile telephony module, as is used in modern mobile telephones—for example a GSM module—or another devices for wireless communication such as, for instance, WLAN or Bluetooth or, for example in regions without mobile telephony coverage, or only poor mobile telephony coverage, a module for satellite communication.

Clearly, however, any other technology for wireless data transmission can be used, and a combination of different technologies is also possible. Thus, for example, an energy supply arrangement fastened on a carrier wagon could comprise a GMS module, the energy supply arrangement communicating, by means of WLAN, with other energy supply arrangements fastened on the same carrier wagon or another carrier wagon of the respective train.

The achievement of the object in respect of a transport container is defined by the features of claim 15. The transport container comprises a fastening device for separably connecting the transport container to a transport container of the same type, or to a vehicle. According to the invention, an energy supply arrangement, as previously described, is then separably connected to the transport container, specifically by means of the first connection device of the energy supply arrangement, which acts in combination with the fastening device of the transport container.

The achievement of the object in respect of a vehicle is defined by the features of claim 16. The vehicle comprises a fastening device for separably connecting the vehicle to a transport container. According to the invention, an energy supply arrangement, as previously described, is then separably connected to the vehicle, specifically by means of a second connection device, which acts in combination with the fastening device of the vehicle.

The vehicle in this case is either a rail vehicle, a motor vehicle such as, for instance, a lorry, or a water craft such as, for example, a ship. In principle, however, it may also be another vehicle such as, for example, an aircraft, having a corresponding fastening device.

The achievement of the object in respect of the method for supplying energy to an energy consumer by means of an energy supply arrangement, as previously described, is defined by the features of claim 17. According to the invention, the mounting device of the energy supply arrangement is connected, by means of the first connection device thereof, to the fastening device of a transport container, the energy consumer, which is preferably an energy consumer arranged on or in the transport container, is connected to the load connection of the energy supply arrangement, and is supplied with energy stored in the energy storage device of the energy supply arrangement.

In a preferred embodiment of the method according to the invention, an energy source is further connected to the energy connection, electrical energy is received at the energy connection and stored, by means of the charging device, in the energy storage device.

Further advantageous embodiments and feature combinations of the invention are given by the following detailed description and the totality of the claims.

### BRIEF DESCRIPTION OF THE DRAWINGS

The drawings used to explain the exemplary embodiment show:

FIG. 1 a block diagram of an energy supply arrangement according to the invention;

FIG. 2 a block diagram of a second embodiment of an energy supply arrangement according to the invention;

FIG. 3 a schematic representation of an adapter frame of an energy supply arrangement according to the invention for mounting the individual components of the energy supply arrangement;

FIG. 4 the adapter frame from FIG. 3 with mounted components;

FIG. 5 the adapter frame from FIG. 3 with a larger energy storage device;

FIG. 6 a more detailed schematic representation of an accumulator module of the energy storage device;

FIG. 7 an accumulator block of the energy storage device;

FIG. 8 a schematic representation of a wheel axle of a container wagon with hydraulic pump mounted thereon;

FIG. 9 a schematic representation of the connection device of a container;

FIG. 10 a schematic representation of a connection element of a container;

FIG. 11 a stud-type fastening device for fastening a container on a vehicle;

FIG. 12 a schematic representation of a transport container;

FIG. 13 a schematic representation of a container wagon;

FIG. 14 the container wagon from FIG. 9 with mounted adapter frames and containers, and

FIG. 15 a schematic representation of a lorry with mounted adapter frame and container.

In principle, parts that are the same in the figures are denoted by the same references.

### WAYS OF EXECUTING THE INVENTION

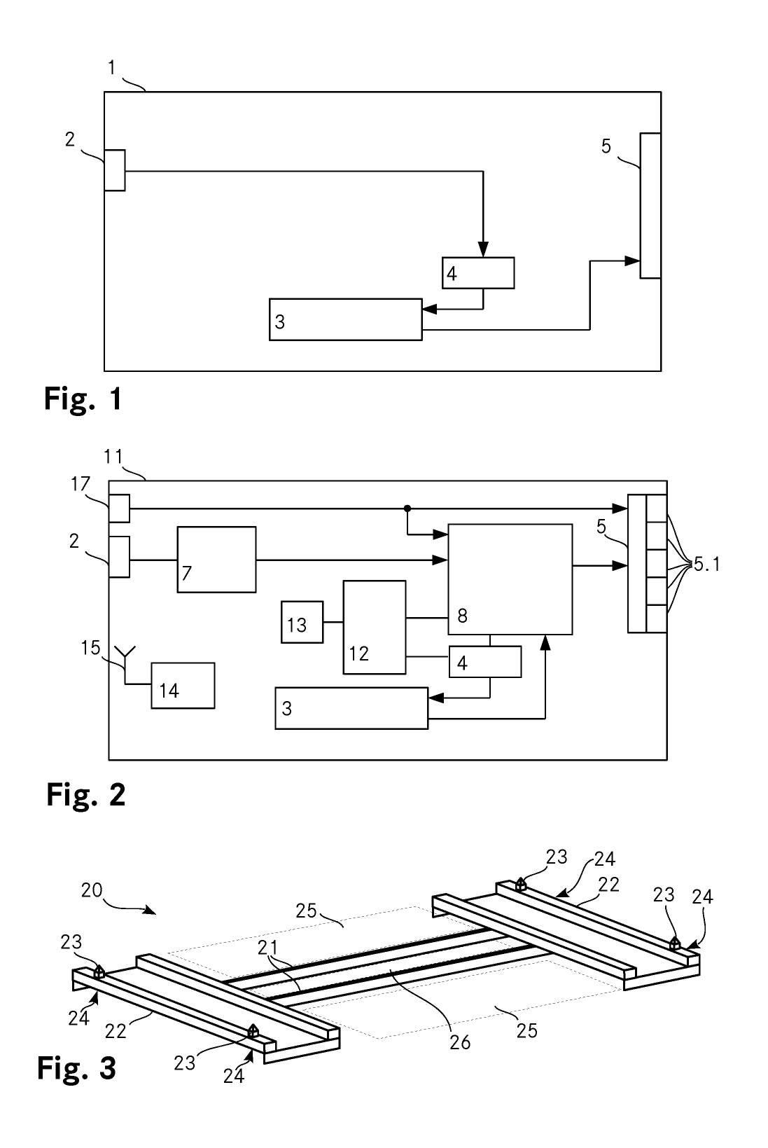

FIG. 1 shows a block diagram of an energy supply 1 according to the invention. The latter comprises an energy connection 2, a battery 3, a charging device 4, by which the energy received at the energy connection 2 can be stored in the form of electrical energy in the battery, and a load connection 5, at which the energy stored in the battery 3 can be output. An energy consumer then only has to be connected to the load connection of the energy supply 1 to enable it to be operated with the energy stored in the battery 3.

FIG. 2 shows a block diagram of a second, more comprehensive embodiment of an energy supply 11 according to the invention. However, the energy delivered at the energy connection 2 is no longer stored in the battery 3 directly by the charging device 4, but is first supplied to a generator 7, which converts it into electrical energy. A current converter 8, in turn, converts the output energy of the generator 7 into a form of electrical energy suitable for charging the battery 3 by means of the charging device 4. The energy stored in the battery, in turn, is routed via the current converter 8 to the load connection 5, which comprises a plurality of outputs 5.1, to which a plurality of energy consumers can be connected.

The energy supply 11 furthermore comprises a controller 12, having an associated auxiliary battery, for system starting and system maintenance of the controller 12. The controller 12 serves to control the various energy flows that are routed via the current converter 8. This means that the controller controls both the energy flow from the energy connection 2 to the charging device 4 and then on to the battery 3, and the energy flow from the battery 2 via the current converter to the energy consumer or energy consumers connected to the load connection 5. In particular, the accumulator or battery management function is performed by the controller 12.

The energy supply 11 furthermore also comprises a monitoring module 14, which is connected to or comprises an antenna 15, and via which it can wirelessly exchange data with other communication partners. The controller 12 may also form a separate unit together with the monitoring module. In this case, further components such as, for example, the current converter, together with its functional units, or also the charging device, may also be integrated into this unit.

The energy supply 11 finally also comprises a mains system connection 17, via which the energy supply 11 can be connected to an external mains electricity supply system. The energy from such a mains system may then be used either directly for feeding the energy consumers connected to the load connection 5, or it is used, controlled by the controller 12, for storage in the battery 3.

FIG. 3 shows a schematic representation of a mounting device, here in the form of an adapter frame 20. The latter comprises two longitudinal members 21, parallel to and spaced apart from each other, which are connected to each other at their ends by a respective transverse member 22, the transverse members 22 being significantly longer than the distance between the two longitudinal members 21, i.e. laterally they project significantly beyond the longitudinal members. This results in a type of double-T frame, the space between the two transverse members 22 being divided into three sub-regions by the two longitudinal members 21. Into two lateral regions 25 from the longitudinal members 21 outward, and into a middle region 26 between the two longitudinal members 21. The two lateral regions 25 and the middle region 26 can thus be used for fastening various components of the energy supply 11. In the selected representation, further components can also be fastened underneath the adapter frame 20, provided that they are placed in such a manner that they do not prevent the adapter frame from being mounted on a vehicle such as, for instance, a rail wagon or a lorry. Such an adapter frame 20 may also comprise further elements such as, for instance longitudinal or transverse struts, which, for example, increase the stability of the frame. In principle, such an adapter frame may also be constructed differently, for example consist of a simple rectangle.

A stud 23 is in each case arranged at the outer ends of the two transverse members 22, i.e. in the corners of the rectangle spanned by the adapter frame 20, the arrangement of the studs 23 corresponding to that on a container wagon or lorry for depositing a container, for transporting the latter. Directly under each stud 23, on the underside of the adapter frame 20, there are openings 24, by means of which the adapter frame 20 can be placed on such a container wagon or lorry. These studs or openings correspond to the connection devices, introduced further above, for connecting the mounting device to a vehicle, or to a container.

The adapter frame 20 is constructed such that, when it is mounted on a carrier wagon, a container fastened thereon comes to sit not more than 11 cm higher than if the container were fastened directly on the carrier wagon. This is most easily achieved in that the height of the adapter frame 20 is 11 cm or less, and specifically without the studs 23 projecting upward over the longitudinal members 21 or transverse members 22. In this way, it is ensured that the container does not sit too high.

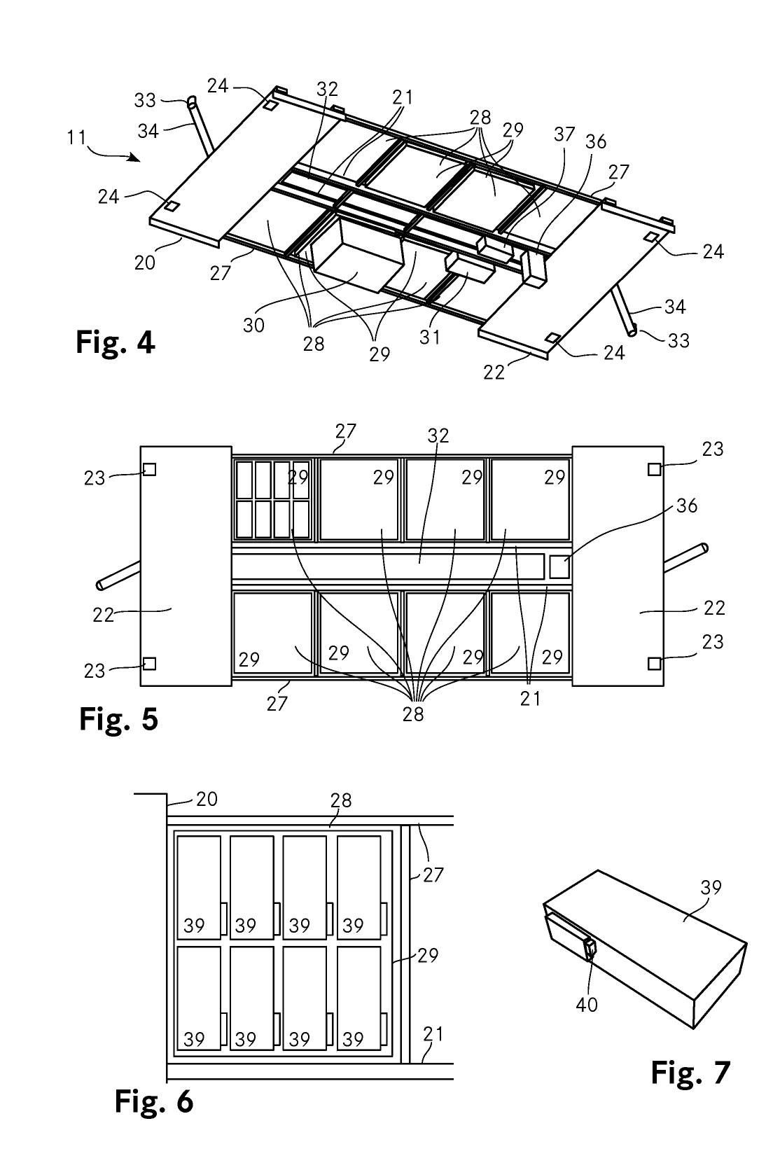

FIG. 4 shown an energy supply 11, the components of which have been fastened to an adapter frame 20 as shown in FIG. 3. FIG. 4 shows the adapter frame 20 obliquely from below. Here, the two lateral regions 25 identified in FIG. 3 are used to accommodate the battery. For this purpose, a respective holding frame 27 is fastened, for example screw-connected, in the two lateral regions 25, each holding frame comprising four equally sized mounting spaces 28 for a respective accumulator module 29. In this way, a total of eight accumulator modules 29 could be accommodated in the adapter frame 20, a respective accumulator module 29 being mounted in the two middle mounting spaces of each holding frame 27 in the example represented in FIG. 4; thus, in total, four accumulator modules 29. The individual accumulator modules 29 are each accommodated in their own watertight housing, and connected to each other, or to the controller.

Further modules of the energy supply 11 are accommodated on the adapter frame 20. Fastened to the underside of the adapter frame 20, for example, is a watertight housing 30 made of steel, in which a plurality of components of the energy supply 11 are accommodated. In the example represented, these are, for example, the controller together with auxiliary battery, the charging device, and also the current converter. In this case, the current converter has a power rating of, for example, 10 to 30 kW. Furthermore, a generator 31, with hydraulic drive, is fastened on the underside of the adapter frame 20. The generator 31, or its incoming-side hydraulic drive (hydraulic motor), is connected, or can be connected (not represented here) to a hydraulic pump, which is mounted on the wheel axle of a vehicle and which supplies the flow of the hydraulic fluid for driving the generator 31. Also fastened to the adapter frame 20 is a tank 36, and a cooler 37 for the hydraulic fluid, which are likewise integrated into the circuit of the hydraulic fluid, i.e. typically connected to corresponding hydraulic hoses or pipes. The electric power produced by the generator 31 is then transmitted to the current converter in the housing 30, where it is processed by means of the controller arranged in the housing 30, i.e. the energy flow to the battery, or to the consumer or consumers, is controlled. The generator 31 has a power rating in the range of, for example, 20 to 30 kW. In principle, clearly, a pneumatic system may also be used instead of a hydraulic system, or in combination therewith, for converting, or transferring, the energy from the wheel axle rotation to the generator.

The energy supply 11 may also comprise further components, not represented, which likewise may be fastened to the adapter frame 20. In addition, further components, which do not belong to the energy supply 11, may additionally be fastened, or fastenable to the adapter frame 20.

In the example represented here, the cables, i.e. the electric power cables and/or signal cables that are needed to connect the individual components and parts of the energy supply, are routed in the middle region 26. This region between the two longitudinal members thus forms a type of cable channel. A cover 32, which is attached in the middle region 26, on both sides of the adapter frame 20, protects these cables from damage, etc. Clearly, further components may also be accommodated in this cable channel, such as, for example, the storage tank for the hydraulic fluid for the hydraulic pump. This hydraulic fluid is normally a hydraulic oil.

FIG. 4 furthermore shows two receptacle outlets 33, which are each arranged at the end of arms 34 that are fastened centrally and rotatably on the outside of the two transverse members 22. The receptacle outlets 33, in turn, are electrically connected to the load connection of the energy supply, which is not visible here, since it likewise is located inside the housing 30. Energy consumers such as, for example, refrigeration units, of containers connected to the adapter frame 20 can be plugged-in at each of these receptacle outlets 33. The energy made available at the load connection, or at the receptacle outlets 33, is provided, for example, in the form of a multiphase mains electricity system having 3 times 400 volts alternating current, with a locally customary frequency, for example 50 or 60 hertz. Obviously, however, this may also be effected in the form of a one-phase or multiphase connection with any amplitudes and/or frequencies, or also as direct current with any voltage.

FIG. 5 shows the adapter frame from FIG. 3, but this time from above and, unlike FIG. 4, with a maximally expanded battery. In this example, all mounting spaces 28 of the two holding frames 27 are equipped with an accumulator module 29. One of the accumulator modules 29 is shown opened, such that there is an unobstructed view of the interior of the housing of this accumulator module 29.

This opened accumulator module 29 is represented in somewhat enlarged form in FIG. 6. It can be seen here that the accumulator module 29 comprises a total of eight accumulator blocks 39, which in the housing are arranged in two rows of four accumulator blocks 39.

Each of these accumulator blocks 39 in turn comprises, respectively, a particular number of interconnected accumulator cells. In the example represented, this is 16 accumulator cells.

Used as accumulator cells, for example, are LiFePO4 round cells, which each have a voltage of about 3.25 volts, and which have cycle stability and are inherently safe. Such lithium iron phosphate round cells have a high energy density and power density. In the case of 16 such cells, an accumulator block 39 delivers a voltage of approximately 52 volts. In the case of 8 accumulator blocks 39 per accumulator module 29, each accumulator module 29 thus delivers a voltage of a good 400 volts. In this way, a capacity of approximately 6.1 kWh can be achieved per accumulator block 39, and thus a capacity of approximately 48.8 kWh per accumulator module 29. In the case of maximally eight accumulator modules 29, this results in a total capacity of approximately 390 kWh.

Obviously, however, other accumulator cells may also be used, which in turn may be combined to form other blocks and modules.

FIG. 7 shows a single accumulator block 39, the selected representation showing, on the front side wall of the accumulator block 39, the connections 40 by which the accumulator blocks 39 can be electrically interconnected.

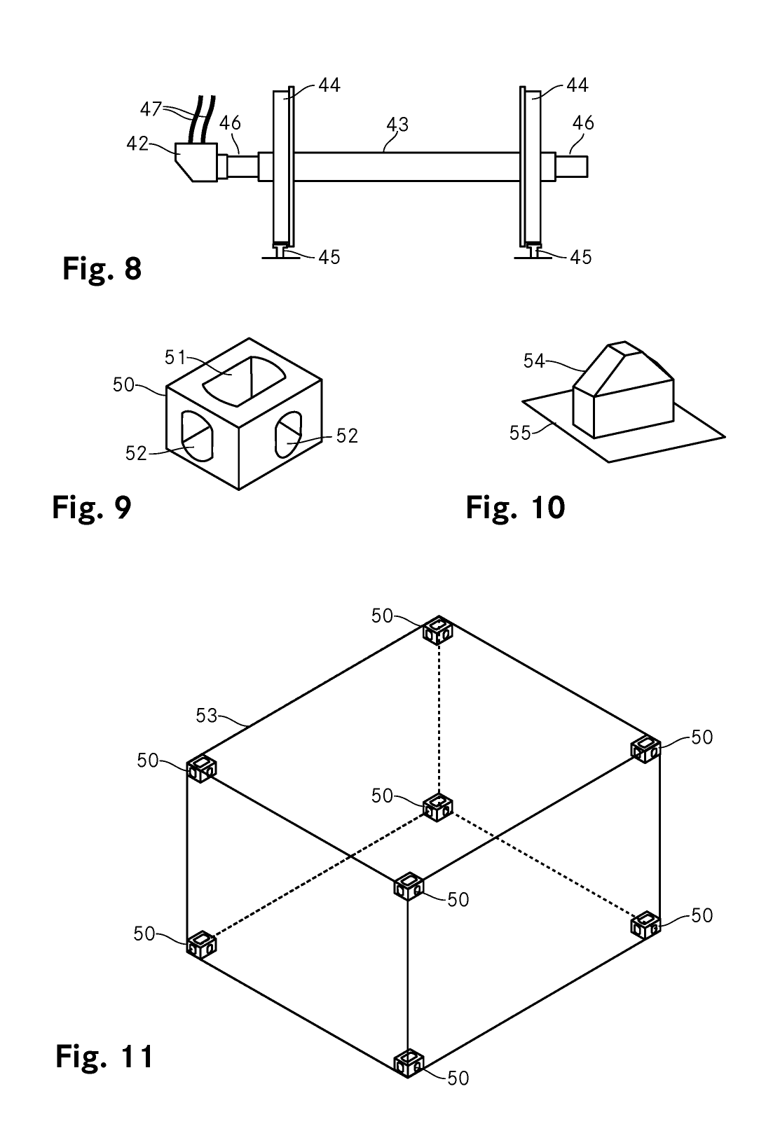

Represented schematically in FIG. 8 is the fastening of the hydraulic pump 42 of a hydraulic generator on the wheel axle 43 of a container carrier wagon. Fastened to the wheel axle 43 are two wheels 44 that roll on indicated rails 45. The wheel axle 43 is longer than the distance between the two wheels 44, such that it projects over the two wheels 44. The hydraulic pump 42 is then fastened axially to such an axle stump, being connected to the hydraulic generator by means of two hydraulic hoses 47. The rotating element of the hydraulic pump 42 is directly fastened axially to the wheel axle 43, whereas the housing of the hydraulic pump 42 is connected to the wagon chassis. The wagon chassis, which is not represented in FIG. 8, has on both sides a respective axle bearing, in which the regions 46 of the wheel axle 43 are carried. In this way, the hydraulic pump 42 utilizes the rotational motion of the wheel axle 43 to pump the hydraulic fluid, by means of the two hydraulic hoses 47, to the hydraulic generator and back again, and thus to drive the hydraulic generator.

FIG. 9 shows a schematic representation of a connection element 50 of the connection device of a container. The connection element 50 is cuboidal, and has three through openings 51, 52, which each connect two opposite lateral faces of the cuboidal connection element 50. The opening 51, which connects the top and bottom face of the connection element 50, is significantly longer than it is wide. The other two openings 52 are typically only slightly longer than they are wide.

FIG. 10 shows a stud 54, which is arranged, for example, on a vehicle 55, and which has a length that is greater than a width of the stud 54. The cross section of the stud in this case is selected such that it can be inserted into the opening 51 of a connection element 50 arranged on a container. In order to facilitate the insertion of the stud 54 into the opening 51 of the connection element 50, the end region of the stud 54 is conical. Typically, there are at least four such studs 54 arranged on the vehicle, such that, when a container is mounted on, the studs 54 on the vehicle are inserted into the openings 51 of the connection elements 50 arranged in the corners of the container, and are accommodated therein.

The studs 54, or the connection elements 50, may be realized such that a mounted-on container can be secured. Thus, for example, there are connection elements 50 on which the conical end region is rotatable, such that it can be secured by rotation after having been inserted into an opening 51.

As represented in FIG. 11, such a connection element is arranged in the corners of a transport container 53 and fixed there. Such connection elements 50 may also be designed as a fixed part of the container. They also may be provided only in some of the corners, for example only in the bottom corners of a container.

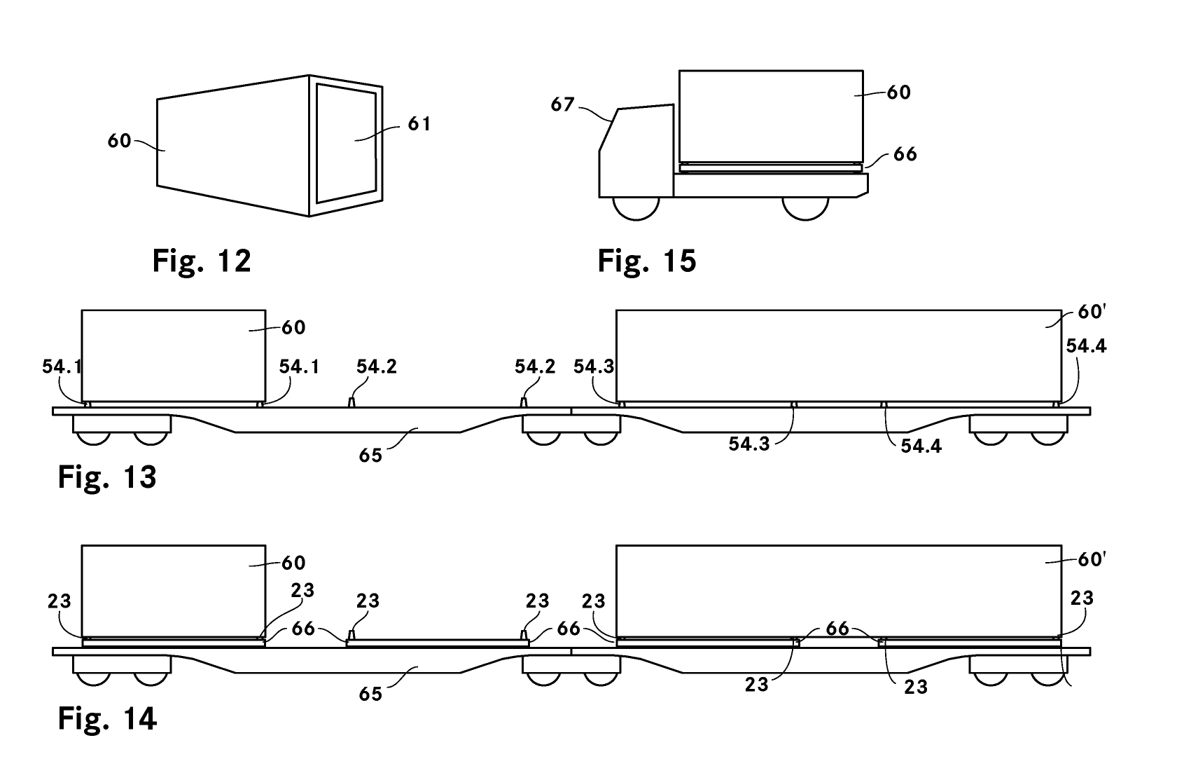

Represented schematically in FIG. 12 is a refrigerated container, such as that which is frequently used for transporting foodstuffs. The refrigerated container 60 has a basic rectangular structure, having a length of 20 ft, a refrigeration unit 61 being arranged on an end face, such that it is within the standard dimensions of the corresponding container standard.

As represented in FIG. 13, the refrigerated container 60 may be fastened to a conventional container wagon 65. In this example, such a container wagon comprises four sets 54.1, 54.2, 54.3, 54.4 of 4 studs—in each case two studs per set 54.1, 54.2, 54.3, 54.4 on both sides of the container wagon 65, at a longitudinal spacing to receive 20-foot containers. In this way, a refrigerated container, depending on its length and on what other containers are also to be transported on the container wagon, can be placed at various positions on the container wagon 65. In the example represented, the container 60 is placed at the first position (as viewed from the left in the representation). The second position is free, and the third and the fourth position are occupied by a second, but longer, refrigerated container 60′.

Instead of then placing the refrigerated containers 60, 60′ directly onto the studs on the container wagon 65, one or more energy supplies 66 according to the invention, with their adapter frames, may be arranged between the refrigerated containers 60, 60′ and the container wagon 65, as is represented in FIG. 14. In this case, it is not necessary for all sets 54.1, 54.2, 54.3, 54.4 of studs to be fitted with an energy supplies 66 according to the invention. Adapter frames 20, such as are represented in FIG. 3, are first placed onto the studs of the four sets 54.1, 54.2, 54.3, 54.4 sets of the container wagon 65, such that the adapter frames come to lie on the respective container positions, the studs of the carrier wagon being inserted into the openings 24 on the underside of the adapter frames 20 of each energy supply 66. There, the adapter frames 20 can be secured if required, for example by means of bolts. The refrigerated containers 60, 60′ are then placed, with their openings arranged in the bottom corners, onto the studs 23 of the adapter frames 20 of the energy supplies 66, and again secured there if necessary. It is then only necessary for the hydraulic pumps of the energy supplies 66 to be fastened to the respective axles and connected, by means of hydraulic hoses, to the generator of the corresponding energy supplies 66, and for the refrigeration units of the refrigerated containers 60, 60′ to be connected to the load connection of the respective energy supplies 66. In this way, the refrigeration units 61 of the refrigerated containers 60, 60′ can be supplied with electric power from the energy supply. Clearly, it is also possible for only one energy supply 66 to be mounted on the container wagon 65, and both refrigerated containers 60. 60′ to be supplied with electric power from this one energy supply 66. Conversely, it is also possible to use a plurality of energy supplies 66, in order to supply electric power to an energy consumer that has a high energy consumption.

FIG. 15, finally, again shows the refrigerated container, which is fastened to a lorry 67, in this case also by means of an energy supply 66 according to the invention. In principle, in the transport of such a container by means of a lorry 67, the energy supply 66 may also be supplied with kinetic energy from the lorry 67. However, this is typically more complex than in the case of container carrier wagons, since in the case of lorries the arrangement and specific design of the wheel axles, or wheels, is not uniform. It may be that the lorry 67 comprises a diesel generator set or similar generator sets for generating electric power, or another source for providing electrical energy that can then be provided at the energy connection for the energy supply 66. Obviously, during the transport by means of a lorry 67, other energy sources such as, for instance, solar or wind energy, may be used to provide energy at the energy connection of the energy supply 66. Frequently, however, but particularly in combined transport with a least possible proportion of distance by road, the capacity present in the battery is sufficient to supply the container with sufficient energy during the road transport.

In general, it is be noted that the specifications given above relating to the capacities, power ratings, etc. of individual units have been selected so as to be appropriate to the example cited, but in principle may be selected optionally. This means that they can and should be matched to the specific application. Clearly, it is also to be noted in this case that the individual items of equipment, or modules, are likewise matched to each other.

In summary, it is to be stated that the invention makes it possible to provide an autonomous energy supply, which can be used in an extremely flexible manner in the transport of goods, in particular with widespread transport containers such as, for instance, an ISO container. It can be used, not only to supply energy to energy consumers such as, for example, refrigeration devices, arranged on or in the transport container, but also to supply energy to energy consumers that do not belong to the transport container, for example arranged on a transport vehicle or at any other location.

1. An energy supply arrangement for supplying an energy consumer with electrical energy, having a mounting device, on which are arranged an energy connection for receiving energy, an energy storage device for storing electrical energy, a charging device for storing energy, received at the energy connection, in the energy storage device, and a load connection for connecting the energy consumer for the purpose of supplying the energy consumer with the electrical energy stored in the energy storage device, characterized in that the mounting device comprises a first connection device, for separable connection to a fastening device of a transport container for connecting the transport container to a transport container of the same type or to a vehicle such as, for example, a rail vehicle, a motor vehicle or a water vehicle.

2. The energy supply arrangement as claimed in claim 1, wherein the mounting device comprises a second connection device, for separable connection to a fastening device of a vehicle for connecting the vehicle to the transport container.

3. The energy supply arrangement as claimed in claim 1, comprising an energy converter for converting the energy received at the energy connection into electrical energy that can be stored in the energy storage device by the charging device, wherein the energy converter preferably comprises a generator for converting a kinetic energy of the vehicle into electrical energy, in particular a generator for converting a rotational energy of a rotating element of the vehicle into electrical energy.

4. The energy supply arrangement as claimed in claim 3, wherein the energy converter comprises a hydraulic generator for converting the rotational energy of a wheel axle of a vehicle into electrical energy, and the hydraulic generator comprises a hydraulic pump that can be fastened to the wheel axle, and an electric generator fastened to the mounting device, and the hydraulic pump is connected, via hydraulic hoses, to the electric generator.

5. The energy supply arrangement as claimed in claim 3, comprising a current converter for converting the electrical energy provided by the energy converter into a form of electrical energy suitable for charging the energy storage device.

6. The energy supply arrangement as claimed in claim 5, wherein the current converter is realized to convert the electrical energy provided by the energy converter into a form of electrical energy that can be used for operating the energy consumer and that can be output at the load connection.

7. The energy supply arrangement as claimed in claim 1, comprising a mains power supply connection, for connecting an external electrical energy source, in particular a mains electricity supply system, wherein the charging device is designed to store electrical energy, received at the mains power supply connection, in the energy storage device, and the energy supply arrangement is preferably designed to directly supply an energy consumer, connected to the load connection, with electrical energy received at the mains power supply connection.

8. The energy supply arrangement as claimed in claim 1, wherein the energy consumer is arranged on or in the transport container and comprises, in particular, a refrigeration device for refrigerating a load volume of the transport container, and the refrigeration device comprises, in particular, a refrigeration unit that can be operated by means of an electric motor.

9. The energy supply arrangement as claimed in claim 1, wherein the transport container is a container, in particular a container having standardized connection devices for connecting the container to a transport vehicle or to containers of the same type, preferably a freight container according to ISO Standard 668.

10. The energy supply arrangement as claimed in claim 1, wherein the energy storage device is of a modular design and comprises a plurality of accumulator cells, which are preferably interconnected to form a plurality of groups.

11. The energy supply arrangement as claimed in claim 1, wherein the mounting device is realized as an adapter frame that can be installed between a vehicle and a transport container to be transported for transport by the vehicle, wherein the adapter frame preferably has a basic rectangular shape, having a length and a width that correspond substantially to a length and a width of the transport container, and having a height that is less than or equal to 25 cm, preferably less than or equal to 11 cm.

12. The energy supply arrangement as claimed in claim 1, comprising a control device, for controlling an energy flow between energy converter, energy storage device and an energy consumer connected to the load connection, wherein the energy supply arrangement comprises an auxiliary energy source, in particular an auxiliary battery present in addition to the energy storage device, for system maintenance and system starting,
wherein the load connection is designed, in particular, for connecting a plurality of energy consumers.

13. The energy supply arrangement as claimed in claim 1, comprising a monitoring device for monitoring a transport container connected to the energy supply arrangement, wherein the monitoring device is designed, in particular, to receive and process signals from sensors, arranged on or in the transport container, for the purpose of monitoring freight transported by the transport container.

14. The energy supply arrangement as claimed in claim 1, comprising a communication device for sending and/or receiving signals, in particular control and/or monitoring signals, wherein the communication device is preferably designed for wireless communication.

15. A transport container, having a fastening device for connecting the transport container to a transport container of the same type, or to a vehicle, wherein an energy supply arrangement as claimed in claim 1 is separably connected to the transport container, by means of the first connection device acting in combination with the fastening device.

16. A vehicle, having a fastening device for connecting the vehicle to a transport container, wherein an energy supply arrangement as claimed in claim 1 is separably fastened to the vehicle by means of a second connection device, acting in combination with the fastening device, for separably connecting the energy supply arrangement to the transport container.

17. A method for supply an energy consumer with electrical energy by means of an energy supply arrangement as claimed in claim 1, wherein the mounting device of the energy supply arrangement is connected, by means of the first connection device, to the fastening device of the transport container, and the energy consumer is connected to the load connection, and is supplied with energy stored in the energy storage device.
